(19) United States
(12) Patent Application Publication
(10) Pub. No.: US 2008/0093188 A1
(43) Pub. Date: Apr. 24, 2008

(54) Hydrokinetic Coupling Device Having A Pre-Defined Head Loss In An Axial Conduit Peripheral To The Piston

(75) Inventor: Roël Verhoog, Gournay Sur Aronde (FR)

Correspondence Address: Matthew Stavish;BERENATO WHITE & STAVISH, Suite 240, 6550 Rock Spring Drive, Bethesda, MD, 20817, US

(73) Assignee: VALEO EMBRAYAGES, Amiens (FR)

(21) Appl. No.: 11/578,691

(22) PCT Filed: Apr. 20, 2005
(86) PCT No.: PCT/FR05/50266

§ 371 Date: Aug. 3, 2007

(30) Foreign Application Priority Data
Apr. 21, 2004 (FR) 0450760

(51) Int. Cl. F16H 45/02

(52) U.S. Cl. 192/3.29; 192/107 R

(57) ABSTRACT

The invention relates to a hydrokinetic coupling device (10) consisting of a case (12) and a lockup clutch (18) comprising a piston (20) which can move axially in relation to the case (12) between an engaged position, in which the piston is applied against an annular transverse face of the case (12), and a disengaged position at a distance from the transverse face of the case (12). According to the invention, the piston (20) is delimited radially by a convex peripheral face (20e) and the case (12) comprises an opposing inner concave face, said two faces radially defining an essentially-annular axial conduit (30). The invention is characterised in that the rotating surfaces (20e, 17i) of the piston (20) and the case (12) are shaped such that the value of the head loss experienced by the fluid circulating in the annular conduit (30) is pre-determined as a function of the axial position of the piston (20) in relation to the case (12).

The invention proposes a hydrokinetic coupling device, in particular for a motor vehicle, of the type comprising:
a case driven by a drive shaft;
a turbine housed in the case and driving a driven shaft; and
a lockup clutch arranged in the case and comprising a piston connected to the driven shaft which is able to move axially with respect to the case between an engaged position in which at least one annular transverse face of the piston is in abutment against an opposite annular transverse face of the case and a disengaged position in which the transverse face of the piston extends at a distance from the opposite annular transverse face of the case,
   of the type in which the axial position of the piston with respect to the case is controlled by modifying the difference in pressure between a first chamber delimited in particular by the transverse faces of the piston and case and a second chamber formed overall from the rest of the internal volume of the case,
   and of the type in which the piston is delimited radially outwards by a convex peripheral face of revolution, and
   the case comprises an opposite internal concave face of revolution, these two annular faces of revolution of the piston and case delimiting radially a roughly annular axial conduit connecting the first chamber to the second chamber.

In a known fashion, a hydrokinetic coupling device connects an input element driven by a drive shaft to an output element driving a driven shaft. The input element is in general a case in which a wheel with vanes fixed to the case, forming an impeller member, and a turbine wheel rotationally fixed to the driven shaft, are arranged face to face.

The rotation of the case and of the impeller member causes a liquid to be put into circulation, which drives the turbine wheel and the driven shaft in rotation, with a certain difference in speeds of rotation between the case and the driven shaft, thus causing a loss of energy transmitted between the drive shaft and the driven shaft.

A lockup clutch is arranged in the case and makes it possible to connect the turbine wheel with the case, as soon as operating conditions so permit, in order to reduce the loss of energy transmitted between the drive shaft and the driven shaft.

The lockup clutch comprises a piston that is able to move axially with respect to the case and turbine wheel and is intended to cooperate by friction means with an opposite internal transverse face of a front radial wall of the case.

The piston divides the case into two chambers, a first front chamber being delimited by the piston and the front wall of the case, the second rear chamber consisting overall of the rest of the internal volume of the case.

The piston is able to move axially between its front, so called coupling, engagement position and its rear, so called decoupling, disengagement position.

The axial movement of the piston is controlled by an electronic device that regulates the difference in fluid pressure between each of the first or second chambers.

When the piston is in the decoupling position, it is able to move in rotation with respect to the case. To prevent any contact between the external peripheral face of revolution of the piston and the opposite internal concave face of revolution of an axial skirt of the case, the piston and axial skirt are mounted with a radial clearance between the opposite annular faces of revolution.

The opposite annular faces of revolution of the piston and of the axial skirt thus delimit an annular axial conduit that connects the first chamber to the second chamber and in which the circulating fluid undergoes a certain pressure drop, which depends in particular on the cross-section of flow of the annular conduit.

However, the piston and case are two elements produced by pressing thick metal sheets. The dimensional differences in the piston and case, in particular the dimensions and shape of their opposite faces of revolution, are therefore relatively great.

Thus the cross-section of flow of the annular conduit is particularly haphazard, and it is therefore impossible to determine precisely the value of the pressure drop undergone by the fluid flowing in the annular conduit.

In order to ensure optimised control of the coupling or decoupling of the lockup clutch, it is necessary to know precisely the difference in pressure between the first chamber and the second chamber of the case.

However, since the pressure drop produced at the annular conduit cannot be determined precisely, it cannot be used for the reliable determination of the difference in pressure between the two chambers in the case.

Thus the lack of precision with regard to the value of the pressure drop has an influence on the precision of the control of the coupling or decoupling of the lockup clutch.

The aim of the invention is to propose a hydrokinetic coupling device for which it is possible to determine precisely the value of the pressure drop undergone by the fluid flowing in the annular conduit.

For this purpose, the invention proposes a hydrokinetic coupling device of the type described above, or characterised in that the cylindrical faces of the piston and case are conformed so that the pressure drop undergone by the fluid flowing in the said annular conduit is predetermined according to the axial position of the piston with respect to the case.

According to other characteristics of the invention:
the pressure drop is constant whatever the axial position of the piston with respect to the case;
the cross-section of flow of the annular conduit varies according to the axial position of the piston with respect to the case;
the cross-section of flow of the annular conduit is constant whatever the axial position of the piston with respect to the case;
the generatrix of the external face of revolution of the piston and the generatrix of the internal face of revolution of the case are parallel;
the generatrix of the external face of revolution of the piston and/or the generatrix of the internal face of revolution of the case comprise at least one rectilinear segment;
the generatrix of the external face of revolution of the piston and/or the generatrix of the internal face of revolution of the case comprise at least one curved segment;
the convex peripheral face of the piston and the concave internal face of revolution of the case extend axially at a distance from the annular transverse face of the piston;
the convex peripheral face of the piston and/or the internal concave face of revolution of the case are produced by machining;
the radial clearance “j” between the convex peripheral face of the piston and the concave internal face of revolution of the case is less than or equal to 1 mm;
the radial clearance “j” between the convex peripheral face of the piston and the concave internal face of revolution of the case is less than or equal to 0.7 mm.

Other characteristics and advantages of the invention will emerge from a reading of the following detailed description, for an understanding of which reference will be made to the accompanying figures, amongst which:

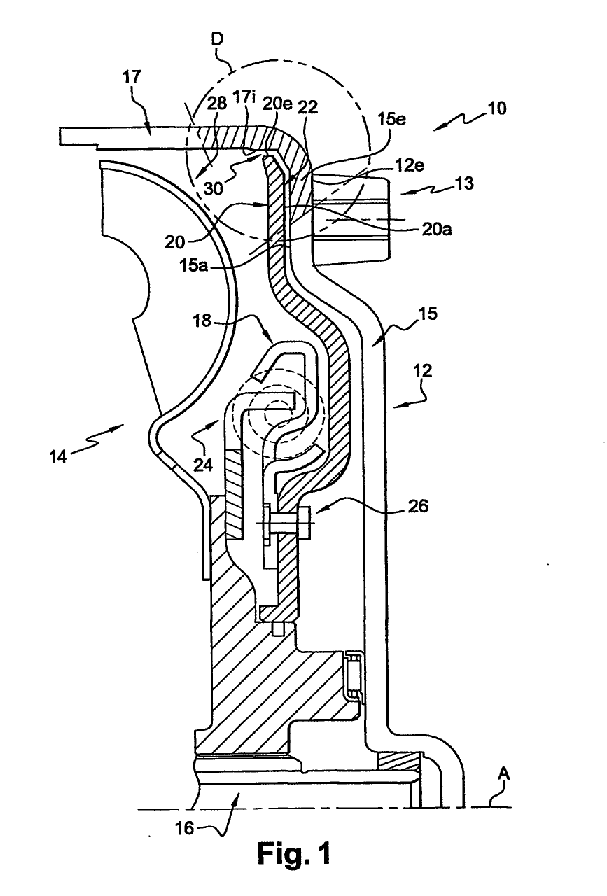

FIG. 1 is a partial schematic representation in axial section of a half view of a hydrokinetic coupling device according to the invention;

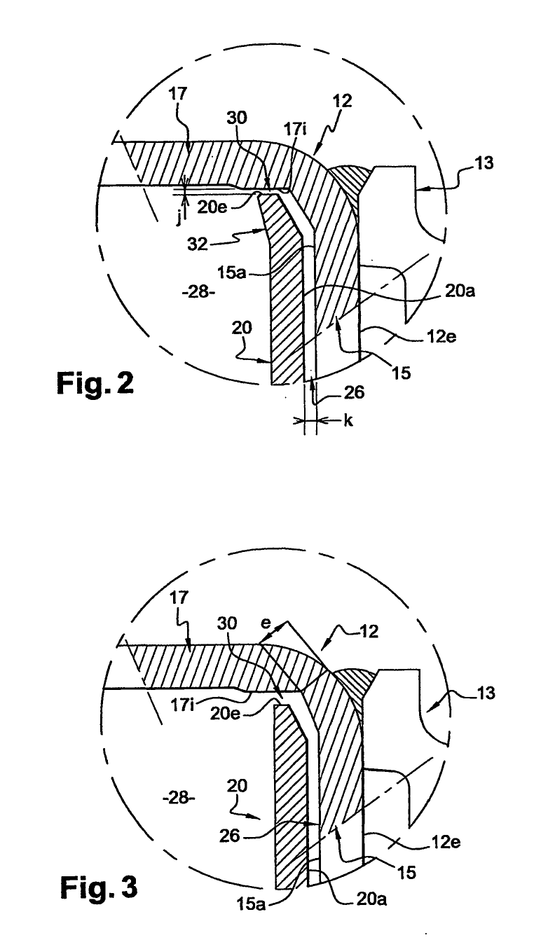

FIGS. 2 to 5 are views to a larger scale of the detail D of the hydrokinetic coupling device depicted in FIG. 1, which illustrate various embodiments of the faces of revolution of the piston and case.

In the description that follows, identical, similar or analogous elements will be designated by the same reference numbers.

The orientation front to rear will be adopted as being the axial direction along the axis A and from right to left as seen in FIG. 1.

FIG. 1 depicts a hydrokinetic coupling device 10 comprising a front case 12 that carries on an external transverse face 12e means 13 for connecting it to the end of a driving shaft (not shown) and in which there are arranged a driven shaft 16, an impeller wheel (not shown) that is rotationally fixed to the case 12, a turbine wheel 12 that is rotationally fixed to the driven shaft 16, and a lockup clutch 18.

The case 12 comprises a front wall 15 extending radially, and the external radial end 15e of which is extended towards the rear, after a portion angled at 90°, by an axial skirt 17. The free rear end edge of the axial skirt 17 is designed to allow the connection of the case 12 with another case (not shown) roughly symmetrical to the case 12, for closing the coupling device 10.

The impeller wheel and the turbine wheel 14 are components of a torque converter of a conventional type, which makes it possible to transmit the drive torque supplied by the engine when the vehicle is started, by means of the fluid, generally oil, contained in the internal volume of the case 12.

The lockup clutch 18 makes it possible to rotationally connect the driven shaft 16 with the case 12, in order to compensate for the loss of energy transmitted to the driven shaft 16 which is due to a “slipping” of the fluid in the torque converter.

The lockup clutch 18 comprises a piston 20 that is rotationally fixed to the turbine wheel 14 and the driven shaft 16 and is able to move axially with respect to the case 12, with respect to the turbine 14 and with respect to the driven shaft 16.

The piston 20 is thus able to occupy a first front engaged position referred to as “coupling”, in which the piston 20 rotationally connects the driven shaft 16 with the case 12, and a second so-called “decoupling” disengaged rear position, in which the driven shaft 16 is not rotationally connected to the case 12 by means of the piston 20.

The document FR-A-2.839.128 describes the functioning of a conventional coupling device, and the coupling and decoupling phases of the piston 20.

The piston 20 comprises a front annular transverse face 20a of abutment against an opposite rear annular transverse face 15a of the front wall 15 of the case 12 when the piston 20 is in the coupling position, and a convex external peripheral face of revolution 20e that delimits the piston 20 radially towards the outside.

The lockup clutch 18 also comprises a torsion damper 24 of conventional structure, which connects the piston 20 to the turbine wheel 14 and which damps the vibrations transmitted to the driven shaft 16 when the clutch is in the coupling position.

The piston 20 divides the internal volume of the case 12 into a first front chamber 26, which is delimited axially by the abutment face 20a of the piston 20 and by the opposite annular transverse face 15a of the front wall 15, and into a second rear chamber 28, which is formed by the rest of the internal volume of the case 12.

As can be seen in more detail in FIGS. 2 to 5, the two chambers 26, 28 communicate with each other by means of an axial conduit 30, annular or tubular in shape overall, which is delimited by the external peripheral face 20e of the piston 20, and by an internal concave face of revolution 17i of the axial skirt 17 that extends opposite the external peripheral face 20e of the piston 20.

The coupling or decoupling of the lockup clutch 18 is controlled by an electronic device (not shown), according in particular to the speed of rotation, the load on the vehicle and the gearbox ratio engaged.

In order to control the movement of the piston 20, with a view to obtaining a coupling, or decoupling, according to a predetermined behaviour of the lockup clutch 18, the controlled device causes a variation in the difference in pressure of fluid in the front chamber 26 and in the rear chamber 28.

The difference in pressure causes the axial movement of the piston 20 towards the front or towards the rear with respect to the case 12, and consequently also causes a circulation of fluid in the axial conduit 30.

However, the fluid flowing in the axial conduit 30 undergoes a pressure drop, the value of which depends in particular on the flow rate of fluid in the axial conduit 30, which depends on the cross-section of flow of the axial conduit 30.

In order to determine precisely the cross-section of flow of the conduit 30, and in accordance with the invention, the external peripheral edge or face 20e of the piston 20 and the internal concave face of revolution 17i of the axial skirt 17 are produced so that the value of the pressure drop undergone by the fluid is predetermined or predefined for each axial position of the piston 20 with respect to the case 12.

For this, the cross-section of flow of the axial conduit 30 must be determined precisely, with minimal dimensional scattering resulting from the mass production of the piston 20 and axial skirt 17.

According to a first embodiment of the invention, the pressure drop is independent of the axial position of the piston 20 with respect to the case 12, that is to say it is constant whatever the axial position of the piston 20 with respect to the case 12.

For this, as can be seen in FIGS. 2, 3 and 5, the external peripheral face 20e of the piston 20 and the internal concave face of revolution 17i of the axial skirt 17 are cylindrical faces of revolution, thus to say their generatrices are straight-line segments parallel to the principal axis A of the coupling device 10.

Thus the cross-section of flow of the annular conduit 30 is constant over the entire length of the conduit and whatever the axial position of the piston 20 with respect to the case 20.

According to another embodiment of the invention, the pressure drop varies according to the axial position of the piston 20 with respect to the case 12.

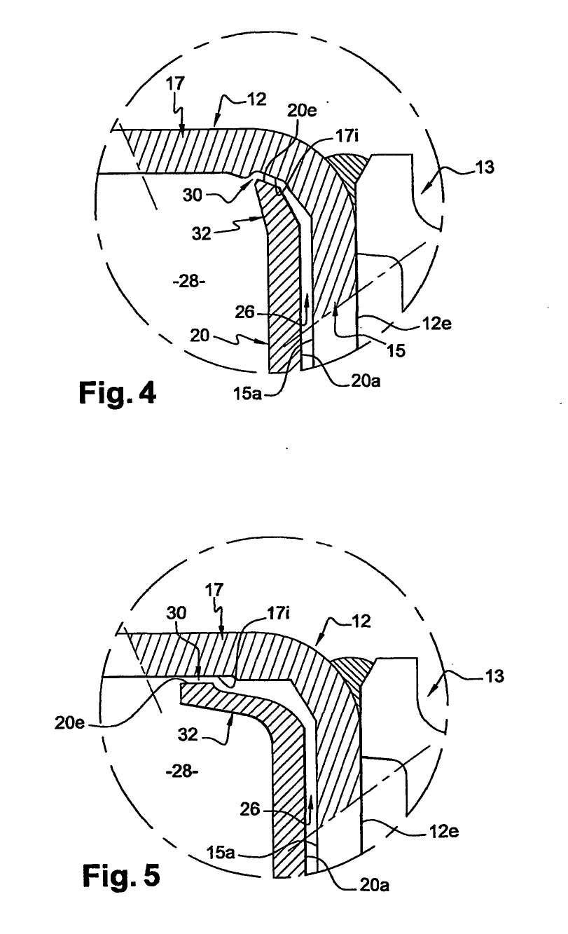

For this, as can be seen in FIG. 4, the external peripheral face 20e of the piston 20 and the internal concave face of revolution 17i of the axial skirt 17 are roughly conical faces of axis A, that is to say their generatrices are straight-line segments inclined with respect to the principal axis A of the coupling device 10.

Thus, according to a preferred aspect of this embodiment depicted in FIG. 4, when the piston 20 moves axially forwards, the cross-section of flow of the axial conduit 30 decreases since the external peripheral face 20e of the piston 20 moves closer to the internal concave face of revolution 17i of the axial skirt 17. Consequently the value of the pressure drop increases.

By way of variant embodiment (not shown) of this embodiment of the invention, for which the value of the pressure drop varies according to the axial position of the piston 20 with respect to the case 12, the generatrices of the external peripheral face 20e of the piston 20 and of the internal concave face of revolution 17i of the axial skirt 17 are curved or curvilinear segments.

According to a preferred embodiment of the invention, the internal concave face of revolution 17i of the axial skirt 17 and/or the external peripheral face 20e of the piston 20 are produced by machining or by a step of additional striking during their pressing, which makes it possible to determine precisely the shape and dimensions of the axial conduit 30.

The manufacture of the external peripheral face 20e of the piston 20 and/or of the internal concave face of revolution 17i of the axial skirt 17 therefore consists of a removal of material.

However, as can be seen in FIG. 3, the machining of the case 12 to produce the internal concave face of revolution 17i causes a reduction in the thickness “e” of the case 12. When the internal concave face of revolution 17i is situated close to the portion of the case 12 that is angled at 90°, the thickness “e” of this portion angled at 90° is greatly reduced there, which results in a weakening and consequently an increased risk of rupture of the case 12.

As can be seen in FIGS. 2, 4 and 5, the external radial end 32 of the piston 20, in which the external peripheral face 20e is produced, is curved towards the rear with respect to the abutment face 20a of the piston 20.

Thus the external peripheral face 20e of the piston 20 and the internal concave face of revolution 17i of the axial skirt 17 extend at a distance from the portion of the case 12 that is angled at 90°.

According to the embodiment depicted in FIG. 5, the radial end 32 of the piston 20 forms an axial skirt making it possible to increase further the axial distance between the external and peripheral face 20e and the piston, and therefore the internal concave face of revolution 17i of the axial skirt 17, with respect to the portion of the case 12 that is angled at 90°.

According to a preferred embodiment, depicted in the figures, the external radial end 32 is produced during the pressing of the piston 20.

However, according to another embodiment (not shown), the external radial end 32 is an annular element attached to the piston, for example by welding or adhesive bonding.

The form and dimensions of the external peripheral face 20e of the piston 20 and of the internal concave face of revolution 17i of the axial skirt 17 being known, it is then possible to determine the pressure drop whatever the operating conditions of the coupling device 10, and for all axial positions of the piston 20 with respect to the case 12.

Amongst the operating conditions of the coupling device 10 that have an influence on the pressure drop, the temperature of the fluid can in particular be cited, which is different when the vehicle is started up or when the vehicle has been operating for a certain length of time.

By way of example, comparative tests were carried out on a coupling device where the axial distance “k” between the front face 20a of the piston 20 and the opposite rear face 15a of the front wall 15 of the case 12 (depicted in FIG. 2), which is determined from the dimensional tolerances of several parts of the coupling, is between 0.3 and 1.3 mm.

It has thus been possible to determine that, when this axial distance “k” is between 0.6 and 1.3 mm, the pressure drop between the front chamber 26 and the rear chamber 28 may be small and cause an excessively great reduction in the coupling speed. It is then difficult to actuate the piston 20 with the required response time, which may impair the driving comfort by creating jolts during this coupling.

It has been possible to determine that, under these conditions, excellent results were obtained when the teachings of the present invention are used.

These have in particular been obtained by optimising the value “j” of the radial clearance between the internal concave face of revolution 17i of the axial skirt and the external peripheral face 20e of the piston 20 (depicted in FIG. 2).

It has thus been determined that values of the radial clearance “j” of less than or equal to 1 mm, or even less than or equal to 0.7 mm, make it possible to obtain a sufficient pressure drop to cause a rapid movement of the piston 20 and prevent jolts during coupling.

The invention has been described as relating to a lockup clutch 18 for which the piston 20 comes directly into abutment against the case 12 in order to effect the coupling, thus in say for a clutch of the “single-face” type. The invention is not limited to this embodiment and the lockup clutch 18 can comprise friction discs interposed axially between the piston 20 and the case 12, that is to say a clutch of the “multi-face” type.

1. A hydrokinetic coupling device (10), for a motor vehicle, comprising:
a case (12) driven by a drive shaft;
a turbine (14) housed in the case (12) and driving a driven shaft (16); and
a lockup clutch (18) arranged in the case (12) and comprising a piston (20) connected to the driven shaft (16) which is able to move axially with respect to the case (12) between an engaged position in which at least one annular transverse face (20a) of the piston (20) is in abutment against an opposite annular transverse face (12e) of the case (12) and a disengaged position in which the transverse face (20a) of the piston (20) extends at a distance from the opposite annular transverse face (12e) of the case (12),
in which the axial position of the piston (20) with respect to the case (12) is controlled by modifying the difference in pressure between a first chamber (26) delimited in particular by the transverse faces (20a, 12e) of the piston (20) and case (12) and a second chamber (28) formed overall from the rest of the internal volume of the case (12),
and in which the piston (20) is delimited radially outwards by a convex peripheral face (20e) of revolution, and the case (12) comprises an opposite internal concave face of revolution (17i), these two faces of revolution (20e, 17) of the piston (20) and case (12) delimiting radially a roughly annular axial conduit (30) connecting the first chamber (26) to the second chamber (28),
wherein the cylindrical faces (20e, 17i) of revolution of the piston (20) and case (12) are conformed so that the pressure drop undergone by the fluid flowing in the said annular conduit (30) is predetermined according to the axial position of the piston (20) with respect to the case (12).

2. Hydrokinetic coupling device (10) according to claim 1, characterised in that the value of the pressure drop is constant whatever the axial position of the piston (20) with respect to the case (12).

3. Hydrokinetic coupling device (10) according to claim 1, characterised in that the cross-section of flow of the annular conduit (30) varies according to the axial position of the piston (20) with respect to the case (12).

4. Hydrokinetic coupling device (10) according to claim 2, characterised in that the cross-section of flow of the annular conduit (30) is constant whatever the axial position of the piston (20) with respect to the case (12).

5. Hydrokinetic coupling device (10) according to claim 1, characterised in that the generatrix of the external face of revolution (20e) of the piston (20) and the generatrix of the internal face of revolution (17i) of the case (12) are parallel.

6. Hydrokinetic coupling device (10) according to claim 1, characterised in that the generatrix of the external face of revolution (20e) of the piston (20) and/or the generatrix of the internal face of revolution (17i) of the case (12) comprise at least one rectilinear segment.

7. Hydrokinetic coupling device (10) according to claim 2, characterised in that the generatrix of the external face of revolution (20e) of the piston (20) and/or the generatrix of the internal face of revolution (17i) of the case (12) comprise at least one curved segment.

8. Hydrokinetic coupling device (10) according to claim 1, characterised in that the convex peripheral face (20e) of the piston (20) and the concave internal face of revolution (17i) of the case (12) extend axially at a distance from the annular transverse face (20a) of the piston (20).

9. Hydrokinetic coupling device (10) according to claim 1, characterised in that the convex peripheral face (20e) of the piston (20) and/or the internal concave face of revolution (17i) of the case (12) are produced by machining.

10. Hydrokinetic coupling device (10) according to claim 1, characterised in that the radial clearance “j” between the convex peripheral face (20e) of the piston (20) and the concave internal face of revolution (17i) of the case (12) is less than or equal to 1 mm;

11. Hydrokinetic coupling device (10) according to claim 1, characterised in that the radial clearance “j” between the convex peripheral face (20e) of the piston (20) and the concave internal face of revolution (17i) of the case (12) is less than or equal to 0.7 mm.
